(19) United States
(12) Patent Application Publication
(10) Pub. No.: US 2018/0158203 A1
(43) Pub. Date: Jun. 7, 2018

(54) OBJECT DETECTION DEVICE AND OBJECT DETECTION METHOD

(71) Applicant: FUJITSU LIMITED, Kawasaki-shi (JP)

(72) Inventors: Jun KANETAKE, Kawasaki (JP); Kimitaka MURASHITA, Atsugi (JP)

(73) Assignee: FUJITSU LIMITED, Kawasaki-shi (JP)

(21) Appl. No.: 15/807,651

(22) Filed: Nov. 9, 2017

(30) Foreign Application Priority Data
Dec. 2, 2016 (JP) 2016-234913

(51) Int. Cl. G06T 7/50; G06T 7/60; G06T 7/73

(52) U.S. Cl. CPC G06T 7/50; G06T 2207/30252; G06T 7/74; G06T 7/60

(57) ABSTRACT

A device includes a memory, and a processor configured to identify a first area including a target object, from a first image captured by a camera at a first time, extract, from the first area, a predetermined number or more of first feature points, identify a second area including the target object, from a second image captured by the camera at a second time, extract, from the second area, second feature points corresponding to the first feature points, correct the second area of the target object, based on first flow amounts from the first feature points to the second feature points and second flow amounts of the first feature points, the second flow amounts being predicted between the first time and the second time, and calculate, based on the corrected second area, a distance from the camera to the target object and a width of the target object.

### CROSS-REFERENCE TO RELATED APPLICATION

This application is based upon and claims the benefit of priority of the prior Japanese Patent Application No. 2016-234913, filed on Dec. 2, 2016, the entire contents of which are incorporated herein by reference.

### FIELD

The embodiments discussed herein are related to an object detection device and so forth.

### BACKGROUND

In recent years, there has been a related technique for analyzing images captured by a camera installed in a moving object such as a vehicle, thereby supporting driver's driving. Feature points and a profile line are extracted from, for example, an image, thereby estimating a range of a stationary object existing at a movement destination of the vehicle, and based on the estimated range of the stationary object, a distance from the vehicle to the stationary object and information of the stationary object are calculated, thereby notifying the driver thereof.

Related techniques are disclosed in Japanese Laid-open Patent Publication No. 2006-129021, Japanese Laid-open Patent Publication No. 2011-109286, Japanese Laid-open Patent Publication No. 2005-123968, Japanese Laid-open Patent Publication No. 2000-161915, and Japanese Laid-open Patent Publication No. 2016-134764.

### SUMMARY

According to an aspect of the invention, an object detection device includes a memory, and a processor coupled to the memory and configured to identify a first area including a target object, from a first image captured by a camera at a first time, extract, from the first area, a predetermined number or more of first feature points, identify a second area including the target object, from a second image captured by the camera at a second time, extract, from the second area, second feature points corresponding to the first feature points, correct the second area of the target object, based on first flow amounts from the first feature points to the second feature points and second flow amounts of the first feature points, the second flow amounts being predicted between the first time and the second time, and calculate, based on the corrected second area, a distance from the camera to the target object and a width of the target object.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining a difference between flow amounts;

FIG. 2 is a diagram illustrating an example of profile lines of a three-dimensional object;

FIG. 3 is a functional block diagram illustrating a configuration of an object detection device according to one of the present embodiments;

FIG. 4 is a diagram illustrating an example of a data structure of video data;

FIG. 5 is a diagram illustrating an example of a data structure of a feature point table;

FIG. 6 is a flowchart illustrating processing performed by a profile line extraction unit;

FIG. 7 is a flowchart illustrating processing performed by a three-dimensional object candidate detection unit;

FIG. 8 is a flowchart illustrating processing performed by a feature point extraction unit;

FIGS. 9A and 9B are flowcharts illustrating processing performed by a flow amount calculation unit;

FIG. 10 is a diagram (part one) for explaining an example of processing performed by a correction unit;

FIG. 11 is a diagram (part two) for explaining an example of the processing performed by the correction unit;

FIG. 12 is a flowchart illustrating the processing performed by the correction unit;

FIG. 13 is a flowchart illustrating processing performed by an output unit;

FIG. 14 is a flowchart illustrating a processing procedure of the object detection device according to one of the present embodiments; and

FIG. 15 is a diagram illustrating an example of a hardware configuration of a computer for realizing the same function as that of the object detection device.

### DESCRIPTION OF EMBODIMENTS

In the above-mentioned related technique, there is a problem that it is difficult to accurately estimate a distance to a stationary object and an area of the stationary object.

In one aspect, an object of the present technology is to provide an object detection device and an object detection method that are each capable of accurately estimating a distance to a stationary object and an area of the stationary object.

Hereinafter, embodiments of the object detection device and the object detection method, disclosed in the present application, will be described in detail, based on drawings. Note that the present technology is not limited to the embodiments.

### Embodiments

Before describing the present embodiments, first and second reference examples for identifying a distance from a vehicle to a three-dimensional object and an area of the three-dimensional object will be described.

The first reference example is a technique for detecting a three-dimensional object by using an optical flow. In what follows, the first reference example will be described. In the first reference example, individual feature points of a three-dimensional object are extracted from each of pieces of image data captured by a camera of a vehicle, and individual feature points of the individual pieces of image data are associated in a time-series manner, thereby calculating position displacement amounts of the feature points. In, for example, a case where coordinates of a feature point at a time t₁ are (x₁, y₁) and coordinates thereof at a time t₂ are (x₂, y₂), a position displacement amount is a distance between the coordinates (x₁, y₁) and the coordinates (x₂, y₂). In the following explanation, the position displacement amount is referred to as a flow amount.

Here, in a case where it is assumed that a feature point on image data exists on a road surface pattern, it is possible to calculate a virtual flow amount of the feature point from installation parameters of the camera and a movement amount of the vehicle. In the following explanation, under an assumption that the feature point is included in the road surface pattern, the virtual flow amount obtained from the installation parameters of the camera and the movement amount of the vehicle is referred to as a “virtual flow amount”. In contrast to this, a flow amount obtained by actually associating individual feature points, based on pieces of image data captured at respective times, is referred to as an observed flow amount.

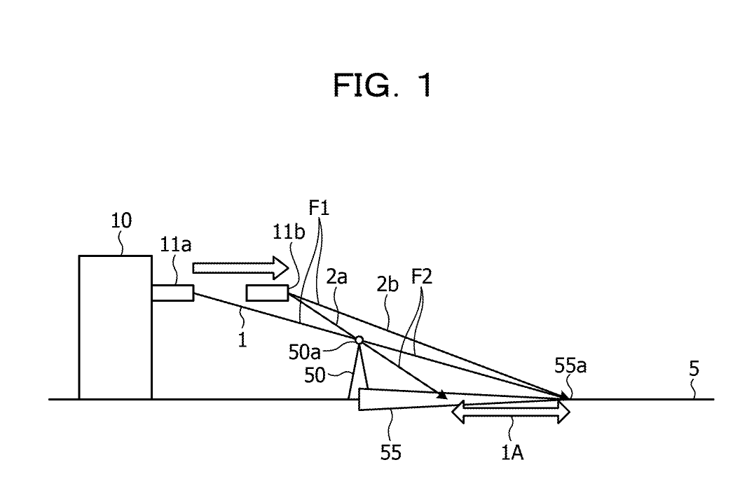

The virtual flow amount is based on the assumption that the feature point is included in the road surface pattern. Therefore, regarding a feature point of a three-dimensional object having a height, the observed flow amount and the virtual flow amount are different from each other. FIG. 1 is a diagram for explaining a difference in flow amounts. As illustrated in FIG. 1, a camera is attached to a vehicle 10, the camera at a time t₁ before a movement of the vehicle 10 is defined as a camera 11a, and the camera at a time t₂ after the movement of the vehicle 10 is defined as a camera 11b. A line segment through the camera 11a and a focus point 50a of a three-dimensional object 50 is defined as a line segment 1. A line segment through the camera 11b and the focus point 50a is defined as a line segment 2a. A line segment through the camera 11b and a point 55a of a road surface pattern 55 is defined as a line segment 2b.

A parallax variation F1 of the virtual road surface pattern 55 in a case where the camera 11a moves to the camera 11b is a difference between a first intersection point and a second intersection point. The first intersection point is an intersection point between a road surface 5 and the line segment 1, and the second intersection point is an intersection point between the line segment 2b and the road surface 5.

A parallax variation F2 of the virtual three-dimensional object 50 is a difference between the first intersection point and a third intersection point. The third intersection point is an intersection point between the line segment 2a and the road surface 5. The parallax variation F2 is greater than the parallax variation F1 by “1A”. Therefore, it is understood that a flow amount of the three-dimensional object 50 becomes greater than a flow amount of the road surface pattern 55. In the first reference example, by using this property, it is determined whether or not a feature point is a feature point of a three-dimensional object.

The above-mentioned virtual flow amount is a flow amount calculated under an assumption that a target is a road surface pattern. Therefore, in a case where a difference between the virtual flow amount and the observed flow amount is large, it is possible to determine that a corresponding feature point is equivalent to the three-dimensional object. In contrast to this, in a case where a difference between the virtual flow amount and the observed flow amount is small, it is possible to determine that the corresponding feature point is a feature point of the road surface pattern (other than the three-dimensional object).

In the first reference example, a range including feature points determined as equivalent to the three-dimensional object is identified as a range of the three-dimensional object, and a distance from the vehicle 10 to the three-dimensional object 50 is calculated from the installation parameters of the camera and the movement amount of the vehicle.

In the first reference example, it is possible to calculate the distance from the vehicle 10 to the three-dimensional object 50 with relatively high accuracy. However, in the first reference example, the number of feature points detected as feature points of the three-dimensional object is decreased in many cases, and in a case where collation of feature points fails, the calculation accuracy of a distance is reduced. In addition, since the number of feature points is low, it is difficult to capture a shape of the entire three-dimensional object.

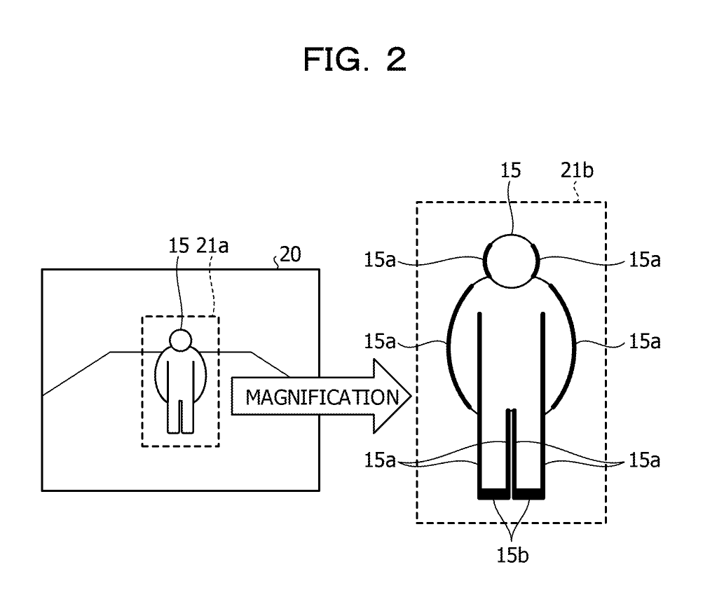

The second reference example is a technique for extracting profile lines vertical on image data, thereby detecting a bundle of the extracted profile lines as a three-dimensional object. FIG. 2 is a diagram illustrating an example of profile lines of a three-dimensional object. In FIG. 2, an image 21b is an image obtained by magnifying an area 21a serving as a portion of an image 20. In FIG. 2, individual profile lines 15a of a three-dimensional object 15 having a height are vertically aligned on the image. In the second reference example, by using this property, an area including the individual profile lines 15a is detected as an area of the three-dimensional object 15.

In the second reference example, the three-dimensional object 15 is detected from a sheet of image data. Therefore, a distance from lower end position 15b of the three-dimensional object 15 to a vehicle is calculated as a distance from the vehicle to the three-dimensional object 15. In the second reference example, it is assumed that the lower end positions 15b are in contact with a road surface, and based on installation parameters of a camera, a distance from the vehicle to the three-dimensional object 15 is calculated.

In the second reference example, it is possible to detect the three-dimensional object 15 from a long distance, and it is possible to capture a shape of the entire three-dimensional object 15. However, in a case where the lower end positions 15b are erroneously detected, it is difficult to accurately detect a distance from the vehicle to the three-dimensional object 15. In addition, if the profile lines 15a of the three-dimensional object 15 are connected to an outline of a background, it is difficult to accurately capture the shape of the entire three-dimensional object in some cases.

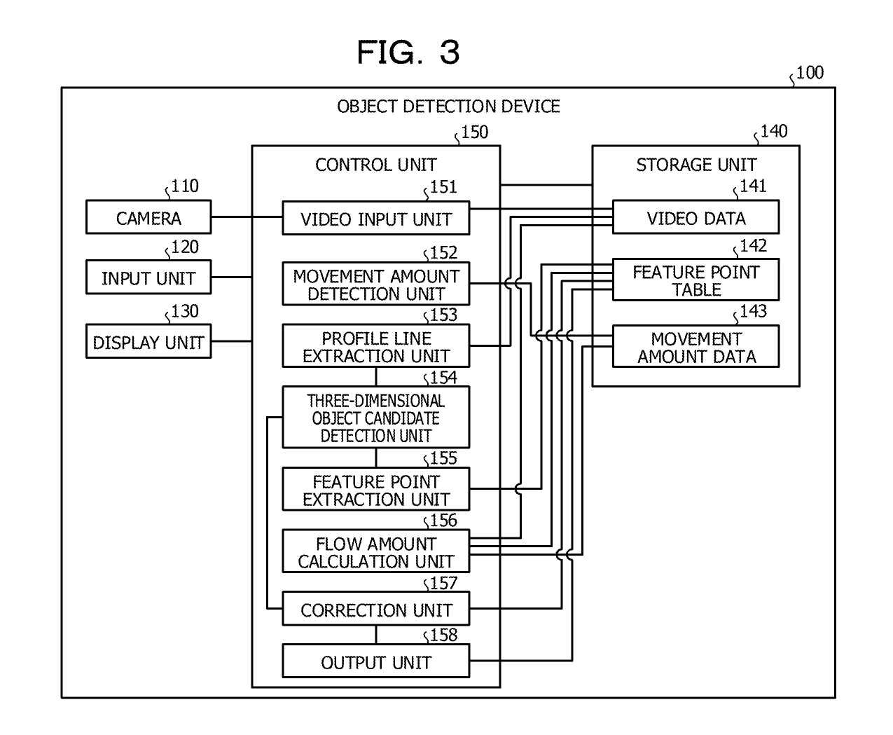

Next, an object detection device according to one of the present embodiments will be described. FIG. 3 is a functional block diagram illustrating a configuration of the object detection device according to one of the present embodiments. As illustrated in FIG. 3, this object detection device 100 includes a camera 110, an input unit 120, a display unit 130, a storage unit 140, and a control unit 150.

The camera 110 is a camera that is installed in a moving object such as a vehicle and that image-captures a video in an image-capturing direction. The camera 110 outputs captured video data 141 to a video input unit 151. The video data 141 is information including successive pieces of image data in a time-series manner.

The input unit 120 is an input device for inputting various kinds of information to the object detection device 100. The input unit 120 is equivalent to a touch panel or an input button, for example.

The display unit 130 is a display device for displaying information output by the control unit 150. The display unit 130 is equivalent to a liquid crystal display, a touch panel, or the like, for example.

The storage unit 140 includes the video data 141, a feature point table 142, and movement amount data 143. The storage unit 140 is equivalent to a semiconductor memory element such as a random access memory (RAM), a read only memory (ROM) or a flash memory, or a storage device such as a hard disk drive (HDD).

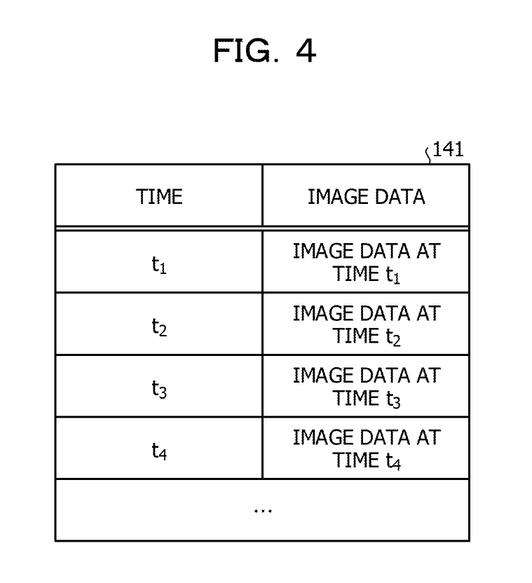

The video data 141 is information including successive pieces of image data in a time-series manner. FIG. 4 is a diagram illustrating an example of a data structure of video data. As illustrated in FIG. 4, the video data 141 associates a time at which image data is captured, and the image data with each other.

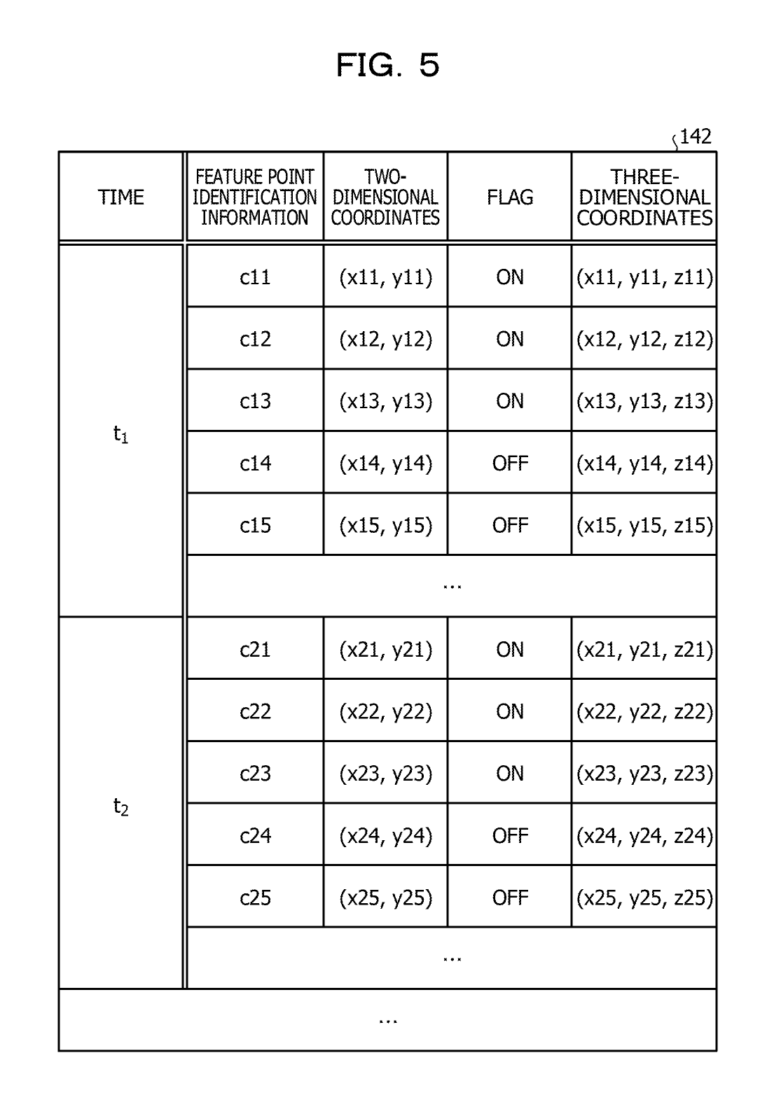

The feature point table 142 is a table that holds various kinds of information related to feature points extracted from the pieces of image data. FIG. 5 is a diagram illustrating an example of a data structure of the feature point table. As illustrated in FIG. 5, this feature point table 142 associates a time, feature point identification information, two-dimensional coordinates, a flag, and three-dimensional coordinates with one another.

The time indicates a time at which a corresponding one of the pieces of image data is captured. The feature point identification information is information for uniquely identifying a feature point extracted from image data captured at a corresponding time. The two-dimensional coordinates indicate coordinates of a feature point on image data. The flag is information for indicating whether or not the feature point is a feature point of a three-dimensional object. A case where the flag is in an “on-state” indicates that the feature point is a feature point of a three-dimensional object. A case where the flag is in an “off-state” indicates that the feature point is a feature point other than that of the three-dimensional object. A feature point other than that of the three-dimensional object is a feature point of a road surface pattern or a feature point of a background, for example. The three-dimensional coordinates indicate three-dimensional coordinates on a space, which correspond to the feature point.

The movement amount data 143 includes a movement direction and a movement velocity of the vehicle at each of times.

The control unit 150 includes the video input unit 151, a movement amount detection unit 152, a profile line extraction unit 153, a three-dimensional object candidate detection unit 154, a feature point extraction unit 155, a flow amount calculation unit 156, a correction unit 157, and an output unit 158. The output unit 158 is an example of a calculation unit. The control unit 150 may be realized by a central processing unit (CPU), a micro processing unit (MPU), or the like. In addition, the control unit 150 may be further realized by a hard-wired logic such as an application specific integrated circuit (ASIC) or a field programmable gate array (FPGA).

The video input unit 151 acquires the video data 141 from the camera 110 and stores the acquired video data 141 in the storage unit 140. In a case where the acquired video data 141 is analog video data, the video input unit 151 converts the analog video data into digital video data and stores the digital video data in the storage unit 140.

The movement amount detection unit 152 is a processing unit that acquires information from a sensor attached to a drive device of the vehicle, thereby detecting a movement amount of the vehicle. The movement amount detection unit 152 stores, in the movement amount data 143, information related to the detected movement amount.

The profile line extraction unit 153 is a processing unit that extracts profile lines from individual pieces of image data of the video data 141. The profile line extraction unit 153 outputs information of profile lines of individual pieces of image data to the three-dimensional object candidate detection unit 154.

The profile line extraction unit 153 extracts edges from the pieces of image data, thereby generating edge images. The profile line extraction unit 153 causes a general differential operator such as Sobel to operate and compares an edge strength obtained by differential processing with a preliminarily defined edge strength threshold value, thereby extracting an edge greater than or equal to the edge strength threshold value, for example.

Since a profile line serving as an extraction target is captured in a vertical direction, the profile line extraction unit 153 performs thinning processing in a lateral direction. Specifically, regarding the extracted edge, the profile line extraction unit 153 compares edge strengths of two pixels adjacent in the lateral direction with each other and performs the thinning processing for defining a peak value as an edge point. The profile line extraction unit 153 connects the extracted edge points, thereby extracting a profile line.

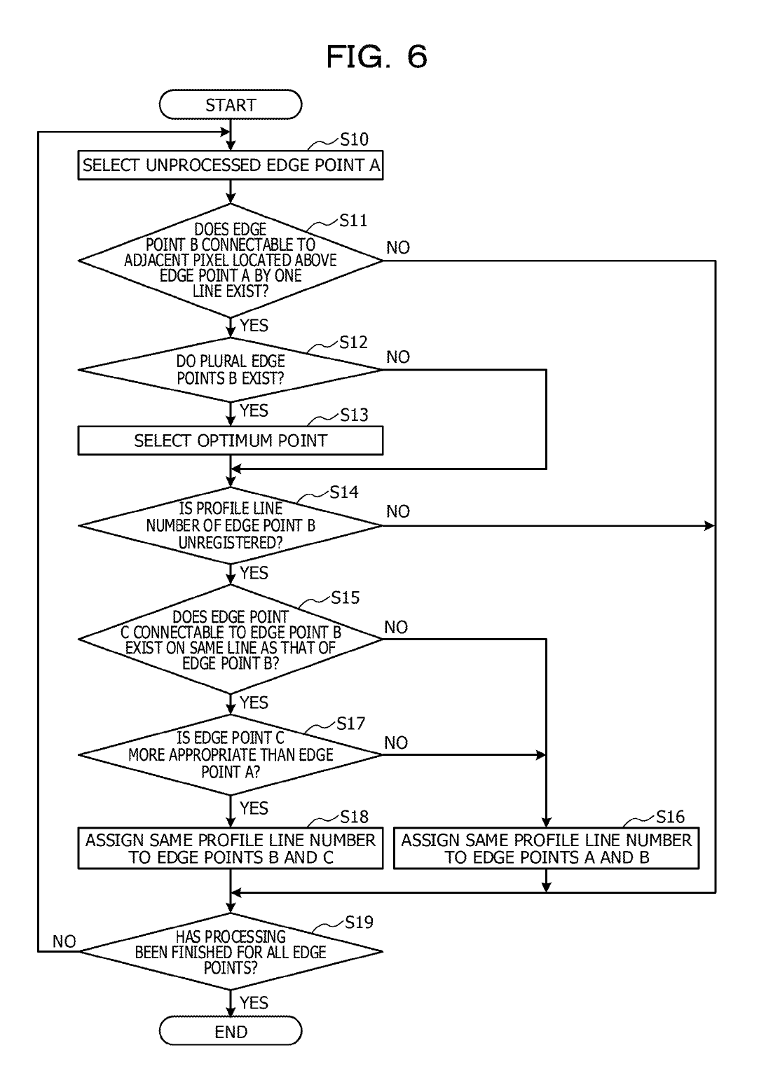

FIG. 6 is a flowchart illustrating processing performed by the profile line extraction unit. As illustrated in FIG. 6, the profile line extraction unit 153 selects an unprocessed edge point A (step S10). The profile line extraction unit 153 determines whether or not an edge point B connectable to an adjacent pixel located above the edge point A by one line exists (step S11).

In a case where no edge point B connectable to an adjacent pixel located above the edge point A by one line exists (step S11: No), the profile line extraction unit 153 makes a transition to step S19. On the other hand, in a case where the edge point B connectable to an adjacent pixel located above the edge point A by one line exists (step S11: Yes), the profile line extraction unit 153 determines whether or not plural edge points B exist (step S12).

In a case where the plural edge points B do not exist (step S12: No), the profile line extraction unit 153 makes a transition to step S14. On the other hand, in a case where the plural edge points B exist (step S12: Yes), the profile line extraction unit 153 selects an optimum point from the plural edge points B (step S13). In step S13, the profile line extraction unit 153 selects, as the optimum point, one of the edge points B, the intensity and the inclination of an edge of which are most similar to the intensity and the inclination, respectively, of an edge of the edge point A.

In a case where a profile line number of the selected edge point B is not unregistered (step S14: No), the profile line extraction unit 153 makes a transition to step S19. On the other hand, in a case where the profile line number of the selected edge point B is unregistered (step S14: Yes), the profile line extraction unit 153 determines whether or not an edge point C connectable to the edge point B exists on the same line as that of the edge point B (step S15).

In a case where no edge point C connectable to the edge point B exists on the same line as that of the edge point B (step S15: No), the profile line extraction unit 153 assigns the same profile line number to the edge points A and B (step S16) and makes a transition to step S19.

On the other hand, in a case where the edge point C connectable to the edge point B exists on the same line as that of the edge point B (step S15: Yes), the profile line extraction unit 153 determines whether or not the edge point C is more appropriate as an edge point to be connected to the edge point B than the edge point A (step S17).

In a case where the edge point C is not more appropriate than the edge point A (step S17: No), the profile line extraction unit 153 makes a transition to step S16. In a case where the intensity and the inclination of the edge point B are more similar to the intensity and the inclination of the edge point A than the intensity and the inclination of the edge point C, the profile line extraction unit 153 determines that the edge point C is not more appropriate than the edge point A, for example.

In a case where the edge point C is more appropriate than the edge point A (step S17: Yes), the profile line extraction unit 153 assigns the same profile line number to the edge points B and C (step S18).

In a case where the processing has not been finished for all edge points (step S19: No), the profile line extraction unit 153 makes a transition to step S10. In a case where the processing has been finished for all the edge points (step S19: Yes), the profile line extraction unit 153 terminates the processing.

A description returns to the explanation of FIG. 3. The three-dimensional object candidate detection unit 154 is a processing unit that detects, based on information of profile lines, a candidate for a range of a three-dimensional object. The three-dimensional object candidate detection unit 154 sets, on image data, grids each having a given size and counts the number of profile lines included in each of the grids. In a case where the number of profile lines included in one of the grids is greater than or equal to a threshold value, the three-dimensional object candidate detection unit 154 detects the relevant grid, as a candidate for a three-dimensional object. Instead of counting the number of profile lines, the three-dimensional object candidate detection unit 154 may count the number of edge points configuring profile lines, thereby detecting a candidate for a three-dimensional object. In the following description, a grid serving as a candidate for a three-dimensional object is referred to as a “three-dimensional object grid”.

After detecting three-dimensional object grids, the three-dimensional object candidate detection unit 154 integrates the three-dimensional object grids. In a case where grids adjacent to each other are three-dimensional object grids, the three-dimensional object candidate detection unit 154 integrates the adjacent three-dimensional object grids. The three-dimensional object candidate detection unit 154 creates a circumscribed rectangle including all profile lines existing within a three-dimensional object grid and detects such a circumscribed rectangle as a candidate for a range of a three-dimensional object. In the following description, the candidate for a range of a three-dimensional object is referred to as a “candidate range”. The three-dimensional object candidate detection unit 154 outputs, to the feature point extraction unit 155 and the correction unit 157, information of individual candidate ranges included in individual pieces of image data.

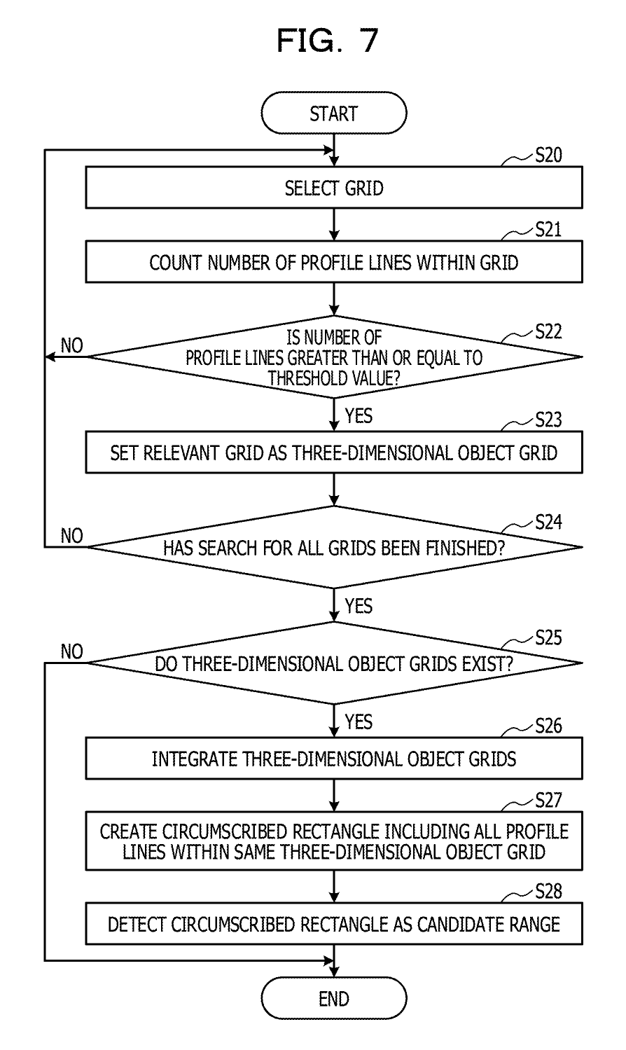

FIG. 7 is a flowchart illustrating processing performed by the three-dimensional object candidate detection unit. As illustrated in FIG. 7, the three-dimensional object candidate detection unit 154 selects one of grids (step S20). The three-dimensional object candidate detection unit 154 counts the number of profile lines within the grid (step S21). The three-dimensional object candidate detection unit 154 determines whether or not the number of profile lines within the grid is greater than or equal to the threshold value (step S22).

In a case where the number of profile lines within the grid is less than the threshold value (step S22: No), the three-dimensional object candidate detection unit 154 makes a transition to step S20. In a case where the number of profile lines within the grid is greater than or equal to the threshold value (step S22: Yes), the three-dimensional object candidate detection unit 154 sets the relevant grid as a three-dimensional object grid (step S23).

The three-dimensional object candidate detection unit 154 determines whether or not a search for all the grids has been finished (step S24). In a case where the search for all the grids has not been finished (step S24: No), the three-dimensional object candidate detection unit 154 makes a transition to step S20. In a case where the search for all the grids has been finished (step S24: Yes), the three-dimensional object candidate detection unit 154 determines whether or not three-dimensional object grids exist (step S25).

In a case where no three-dimensional object grid exists (step S25: No), the three-dimensional object candidate detection unit 154 terminates the processing. On the other hand, in a case where three-dimensional object grids exist (step S25: Yes), the three-dimensional object candidate detection unit 154 integrates the three-dimensional object grids in a case where grids adjacent to each other are the three-dimensional object grids (step S26).

The three-dimensional object candidate detection unit 154 creates a circumscribed rectangle including all profile lines within the same three-dimensional object grid (step S27). The three-dimensional object candidate detection unit 154 detects the circumscribed rectangle as a candidate range (step S28).

A description returns to the explanation of FIG. 3. The feature point extraction unit 155 is a processing unit that extracts feature points included in a candidate range of image data. The feature point extraction unit 155 performs corner detection of Harris, thereby identifying a corner point, for example. Based on another corner point detection method other than the corner detection of Harris, the feature point extraction unit 155 may identify a corner point. In the following description, a corner point detected by the feature point extraction unit 155 by using the corner detection method is referred to as a “feature point”.

In a case where the number of feature points included in a candidate range is less than a predetermined number, the feature point extraction unit 155 relaxes a condition for feature point extraction and repeatedly performs processing for extracting feature points again. In a case of identifying feature points by using the corner detection of Harris, the feature point extraction unit 155 calculates an autocorrelation property between a certain point and the periphery thereof, and in a case where the autocorrelation property is less than a threshold value Sₜₕ, the feature point extraction unit 155 identifies the certain point as a feature point, for example. Therefore, in order to extract more feature points, the feature point extraction unit 155 raises the threshold value Sₜₕ, thereby relaxing the condition for the feature point extraction. For each of candidate ranges, the feature point extraction unit 155 repeatedly performs the above-mentioned processing.

The feature point extraction unit 155 registers, in the feature point table 142, information of feature points. The information of feature points includes a time of image data, feature point identification information, and two-dimensional coordinates, for example.

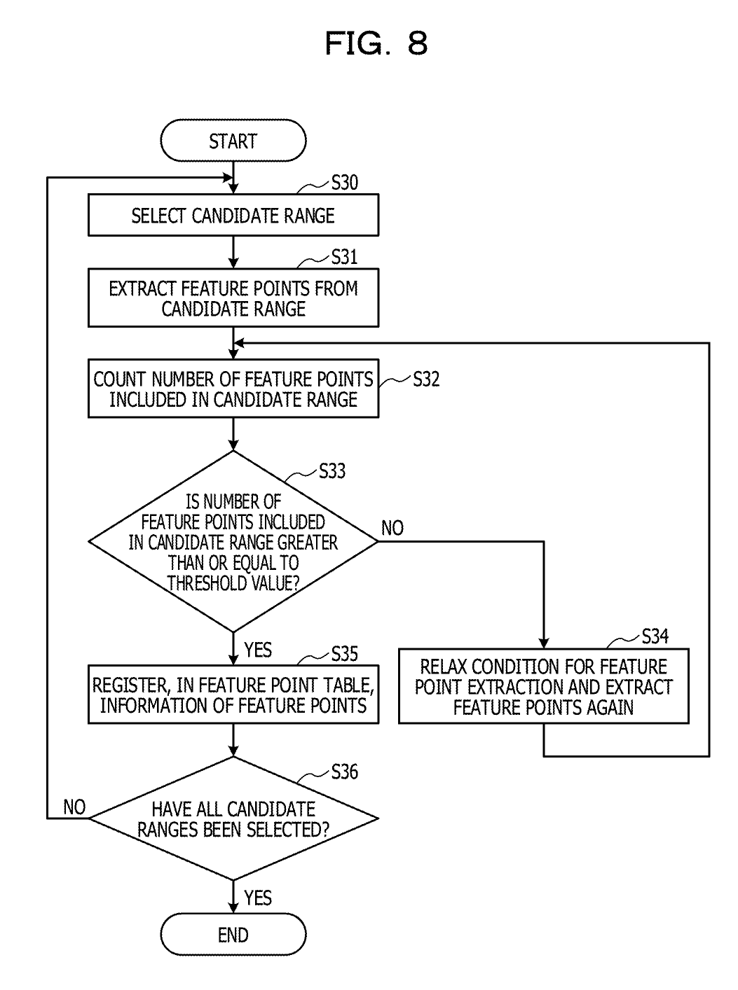

FIG. 8 is a flowchart illustrating processing performed by the feature point extraction unit. As illustrated in FIG. 8, the feature point extraction unit 155 selects one of candidate ranges (step S30). The feature point extraction unit 155 extracts feature points from the candidate range (step S31). The feature point extraction unit 155 counts the number of feature points included in the candidate range (step S32).

The feature point extraction unit 155 determines whether or not the number of feature points included in the candidate range is greater than or equal to a threshold value (step S33). In a case where the number of feature points included in the candidate range is less than the threshold value (step S33: No), the feature point extraction unit 155 relaxes the condition for feature point extraction and extracts feature points again (step S34), and makes a transition to step S32.

On the other hand, in a case where the number of feature points included in the candidate range is greater than or equal to the threshold value (step S33: Yes), the feature point extraction unit 155 registers, in the feature point table 142, information of the feature points (step S35). In a case where all the candidate ranges have not been selected (step S36: No), the feature point extraction unit 155 makes a transition to step S30. In a case where all the candidate ranges have been selected (step S36: Yes), the feature point extraction unit 155 terminates the processing.

A description returns to the explanation of FIG. 3. The flow amount calculation unit 156 is a processing unit that calculates an observed flow amount and a virtual flow amount for each of feature points.

An example of processing with which the flow amount calculation unit 156 calculates an observed flow amount will be described. The flow amount calculation unit 156 references the feature point table 142, thereby identifying a position at a current time t, which corresponds to a feature point at a time “t−α”. It is assumed that a value of “a” is preliminarily set by an administrator. The flow amount calculation unit 156 uses, as a template, an image of an area peripheral to the feature point at the time “t−α” and performs matching processing between the template and image data at the time “t−α”, thereby identifying a position in image data at the time t, which corresponds to the feature point at the time “t−α”.

Based on general template matching as the matching processing, a position having the highest degree of collation is determined, and in a case where the degree of collation is greater than or equal to a threshold value, it is determined that collation succeeds. Based on a position of the feature point at the time “t−α”, the flow amount calculation unit 156 calculates, as an observed flow amount, a distance from the position of the feature point at the time “t−α” to a position at which the collation succeeds. As the template matching, a sum of absolute difference (SAD), a sum of squared difference (SSD), and so forth are cited, for example.

Based on a relationship between the movement amount data 143, the position of the feature point at the time “t−α”, and a position of a feature point at which the collation succeeds at the time t, the flow amount calculation unit 156 calculates three-dimensional coordinates of the feature point at the time t. The flow amount calculation unit 156 registers, in the feature point table 142, information of the three-dimensional coordinates of the feature point at the time t.

In a case where the observed flow amount of the feature point is less than a threshold value, the flow amount calculation unit 156 determines that the feature point is a feature point of a background. The flow amount calculation unit 156 references the feature point table 142 and sets, to an “off-state”, a flag corresponding to the feature point determined as a feature point of the background. In the feature point table 142, an initial value of a flag of each of feature points is set to an “on-state”, for example.

For individual feature points registered in the feature point table 142, the flow amount calculation unit 156 repeatedly performs the above-mentioned processing. For a feature point a flag of which is in an “on-state”, the flow amount calculation unit 156 performs after-mentioned processing for calculating a virtual flow amount.

An example of processing with which the flow amount calculation unit 156 calculates a virtual flow amount will be described. Based on a position of a feature point at the time “t−α” and a movement amount between the time “t−α” and the time t, the flow amount calculation unit 156 calculates a virtual flow amount. The flow amount calculation unit 156 acquires, from the movement amount data 143, information of the movement amount between the time “t−α” and the time t.

Subsequently, based on a difference between an observed flow amount corresponding to the feature point and the virtual flow amount, the flow amount calculation unit 156 determines whether the feature point is a feature point of a road surface pattern or a feature point of a three-dimensional object. In a case where the difference between the observed flow amount corresponding to the feature point and the virtual flow amount is greater than or equal to a threshold value, the flow amount calculation unit 156 determines that the relevant feature point is the feature point of the three-dimensional object. On the other hand, in a case where the difference between the observed flow amount corresponding to the same feature point and the virtual flow amount is less than the threshold value, the flow amount calculation unit 156 determines that the relevant feature point is the feature point of the road surface pattern. In the following description, a feature point of a three-dimensional object is arbitrarily referred to as a “three-dimensional object feature point”, and a feature point of a road surface pattern is arbitrarily referred to as a “road surface feature point”.

The flow amount calculation unit 156 references the feature point table 142 and sets, to an “off-state”, a flag corresponding to a feature point determined as the road surface feature point. The flow amount calculation unit 156 leaves, in an “on-state”, a flag corresponding to a feature point determined as the three-dimensional object feature point.

Subsequently, the flow amount calculation unit 156 performs update processing for the feature point table 142. The flow amount calculation unit 156 compares a position at the time t, at which collation succeeds based on the template matching, with a position of a feature point at the time t, for example. In a case where the positions of the respective feature points do not overlap with each other, the flow amount calculation unit 156 registers, in the feature point table 142 as a new feature point, the position at the time t, at which the collation succeeds.

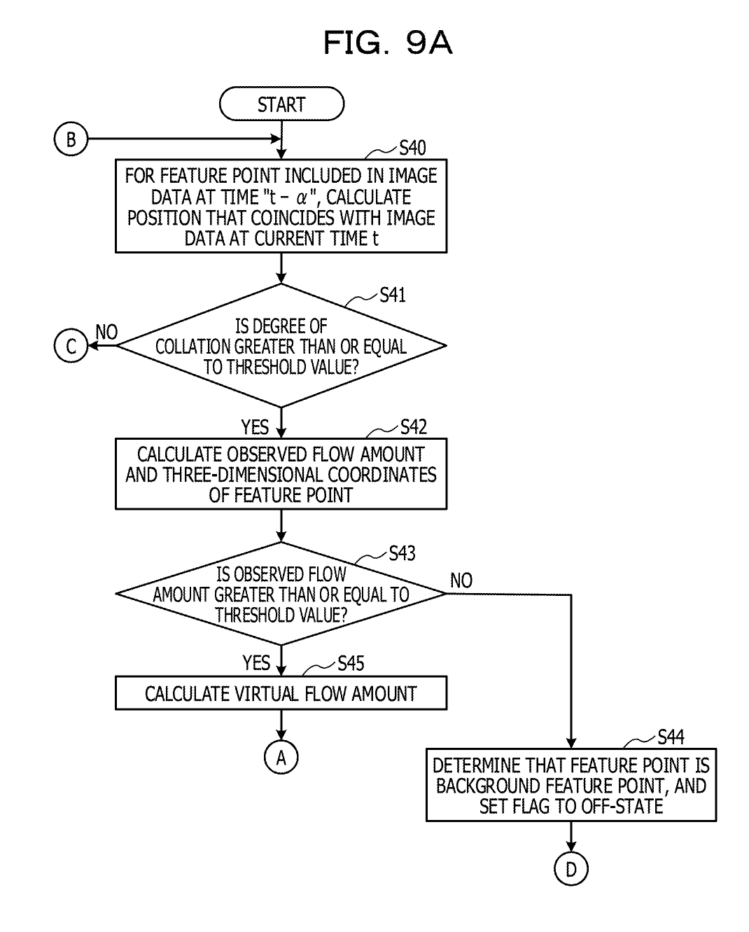

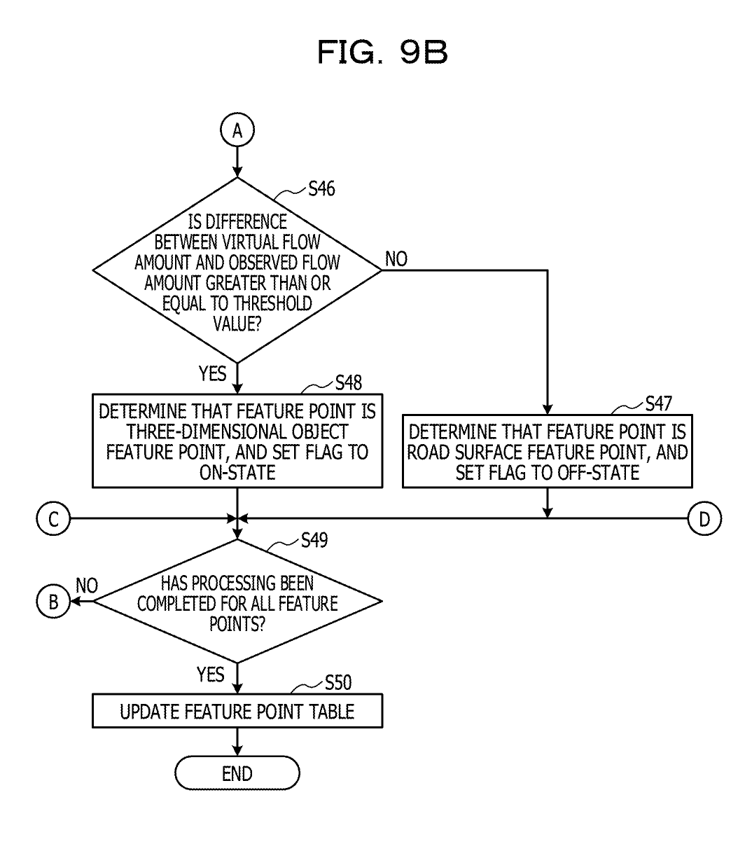

FIG. 9 is a flowchart illustrating processing performed by the flow amount calculation unit. As illustrated in FIG. 9, for a feature point included in the image data at the time “t−α”, the flow amount calculation unit 156 calculates a position that coincides with the image data at the current time t (step S40). The flow amount calculation unit 156 determines whether or not the degree of collation is greater than or equal to the threshold value (step S41).

In a case where the degree of collation is less than the threshold value (step S41: No), the flow amount calculation unit 156 makes a transition to step S49. In a case where the degree of collation is greater than or equal to the threshold value (step S41: Yes), the flow amount calculation unit 156 calculates an observed flow amount and three-dimensional coordinates of the feature point (step S42).

In a case where the observed flow amount is less than the threshold value (step S43: No), the flow amount calculation unit 156 determines that the feature point is a background feature point and sets a flag to an off-state (step S44), and makes a transition to step S49.

On the other hand, in a case where the observed flow amount is greater than or equal to the threshold value (step S43: Yes), the flow amount calculation unit 156 calculates a virtual flow amount (step S45). The flow amount calculation unit 156 determines whether or not a difference between the virtual flow amount and the observed flow amount is greater than or equal to the threshold value (step S46).

In a case where the difference between the virtual flow amount and the observed flow amount is less than the threshold value (step S46: No), the flow amount calculation unit 156 determines that the feature point is a road surface feature point and sets a flag to an off-state (step S47), and makes a transition to step S49.

On the other hand, in a case where the difference between the virtual flow amount and the observed flow amount is greater than or equal to the threshold value (step S46: Yes), the flow amount calculation unit 156 determines that the feature point is a three-dimensional object feature point and sets the flag to an on-state (step S48), and makes a transition to step S49.

In a case where the processing has not been completed for all feature points (step S49: No), the flow amount calculation unit 156 makes a transition to step S40. On the other hand, in a case where the processing has been completed for all the feature points (step S49: Yes), the flow amount calculation unit 156 updates the feature point table 142 (step S50).

A description returns to the explanation of FIG. 3. The correction unit 157 is a processing unit that corrects a candidate area, based on a three-dimensional object feature point. The correction unit 157 outputs, to the output unit 158, information of a final candidate area of a three-dimensional object.

In the same way as the three-dimensional object candidate detection unit 154, the correction unit 157 sets grids and selects a certain grid. The correction unit 157 acquires, from the feature point table 142, three-dimensional object feature points included in the selected grid and identifies a circumscribed rectangle of the acquired three-dimensional object feature points. In the following description, the circumscribed rectangle identified by the correction unit 157 is referred to as a “generated area”. In the feature point table 142, a flag of each of feature points serving as respective three-dimensional object feature points is in an “on-state”.

The correction unit 157 compares a candidate area identified from the same grid and the generated area with each other. In a case where a difference between the candidate area and the generated area is greater than or equal to a threshold value, the correction unit 157 corrects the candidate area in conformity with the generated area.

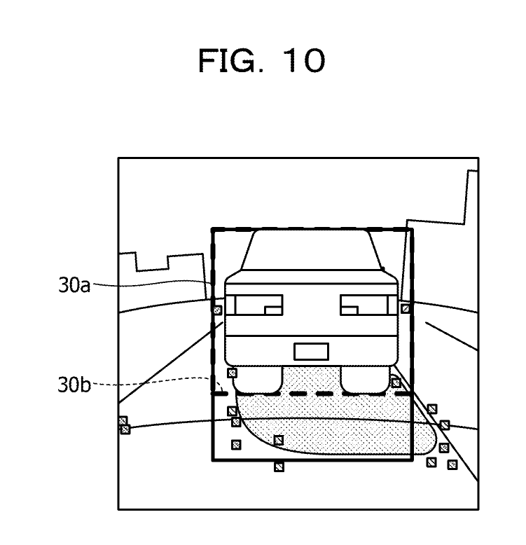

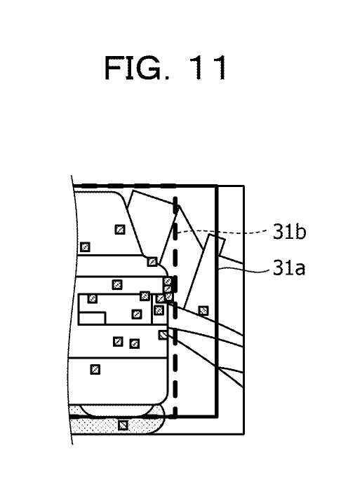

Each of FIG. 10 and FIG. 11 is a diagram for explaining an example of processing performed by the correction unit. In the example illustrated in FIG. 10, a candidate area 30a and a generated area 30b are illustrated. Since a difference between the candidate area 30a and the generated area 30b is greater than or equal to the threshold value, the correction unit 157 corrects the candidate area 30a in conformity with the generated area 30b.

In the example illustrated in FIG. 11, a candidate area 31a and a generated area 31b are illustrated. Since a difference between the candidate area 31a and the generated area 31b is greater than or equal to the threshold value, the correction unit 157 corrects the candidate area 31a in conformity with the generated area 31b.

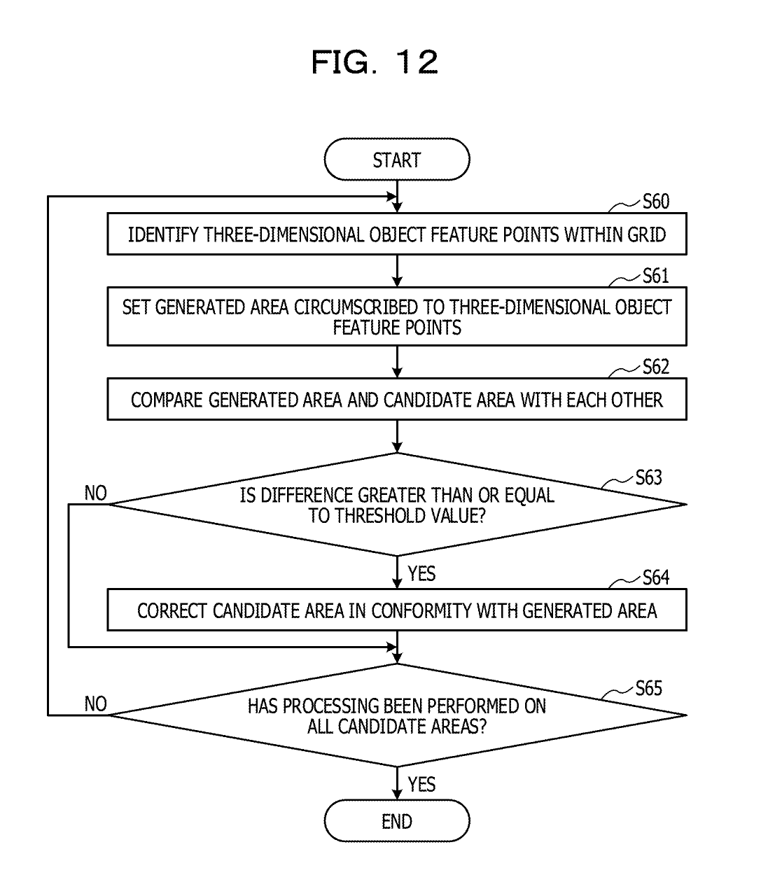

FIG. 12 is a flowchart illustrating the processing performed by the correction unit. As illustrated in FIG. 12, the correction unit 157 identifies three-dimensional object feature points within a grid (step S60). The correction unit 157 sets a generated area circumscribed to the three-dimensional object feature points (step S61).

The correction unit 157 compares the generated area and a candidate area with each other (step S62). In a case where a difference therebetween is less than the threshold value (step S63: No), the correction unit 157 makes a transition to step S65. In a case where the difference is greater than or equal to the threshold value (step S63: Yes), the correction unit 157 corrects the candidate area in conformity with the generated area (step S64).

In case where the processing has not been finished for all candidate areas (step S65: No), the correction unit 157 makes a transition to step S60. In case where the processing has been finished for all the candidate areas (step S65: Yes), the correction unit 157 terminates the processing.

The output unit 158 is a processing unit that identifies a distance from the vehicle to a three-dimensional object and an area of the three-dimensional object and that causes the display unit 130 to display these. The output unit 158 acquires, from the feature point table 142, information of three-dimensional object feature points included in a candidate area of a three-dimensional object, thereby identifying a three-dimensional position of the three-dimensional object. Average values of three-dimensional coordinates of the three-dimensional object feature points included in the candidate area may be defined as the three-dimensional position of the three-dimensional object, and a three-dimensional position of a three-dimensional object feature point that is included in the three-dimensional object feature points and that is nearest to the vehicle may be defined as the three-dimensional position of the three-dimensional object, for example. In addition, the output unit 158 may use, as information of an area of the three-dimensional object, the candidate area without change or may output information of only a width of the candidate area.

The three-dimensional position of the vehicle may be calculated in any manner. The output unit 158 may calculate the three-dimensional coordinates of the vehicle by using a running start position and the movement amount data 143 or may calculate the three-dimensional position of the vehicle by using a global positioning system (GPS) function, for example.

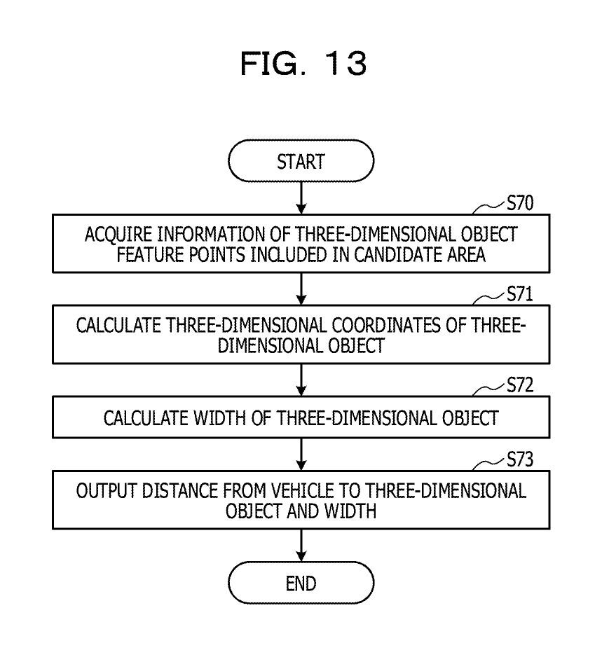

FIG. 13 is a flowchart illustrating processing performed by the output unit. As illustrated in FIG. 13, the output unit 158 acquires information of three-dimensional object feature points included in a candidate area (step S70). The output unit 158 calculates three-dimensional coordinates of a three-dimensional object (step S71). The output unit 158 calculates a width of the three-dimensional object (step S72). The output unit 158 outputs a distance from the vehicle to the three-dimensional object and the width (step S73).

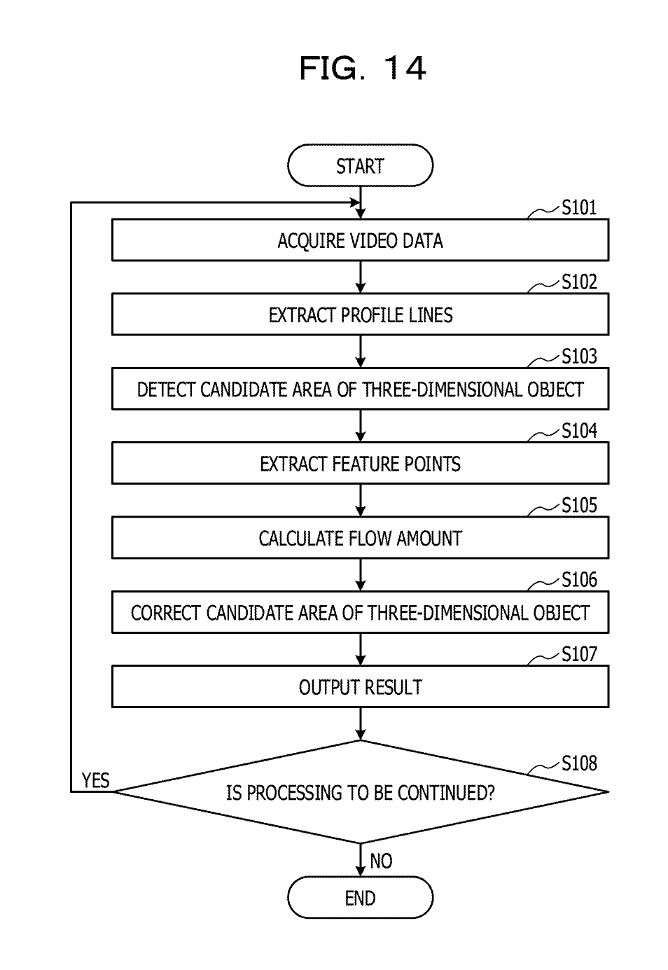

Next, a processing procedure of the object detection device 100 according to one of the present embodiments will be described. FIG. 14 is a flowchart illustrating a processing procedure of the object detection device according to one of the present embodiments. As illustrated in FIG. 14, the video input unit 151 in the object detection device 100 acquires the video data 141 (step S101).

The profile line extraction unit 153 in the object detection device 100 extracts profile lines (step S102). A specific processing procedure in step S102 is equivalent to the flowchart illustrated in FIG. 6.

The three-dimensional object candidate extraction unit 154 in the object detection device 100 detects a candidate area of a three-dimensional object (step S103). A specific processing procedure in step S103 is equivalent to the flowchart illustrated in FIG. 7.

The feature point extraction unit 155 in the object detection device 100 extracts feature points (step S104). A specific processing procedure in step S104 is equivalent to the flowchart illustrated in FIG. 8.

The flow amount calculation unit 156 in the object detection device 100 calculates a flow amount (step S105). A specific processing procedure in step S105 is equivalent to the flowchart illustrated in FIG. 9.

The correction unit 157 in the object detection device 100 corrects the candidate area of the three-dimensional object (step S106). A specific processing procedure in step S106 is equivalent to the flowchart illustrated in FIG. 12.

The output unit 158 in the object detection device 100 outputs a result (step S107). A specific processing procedure in step S107 is equivalent to the flowchart illustrated in FIG. 13.

In a case of continuing the processing (step S108: Yes), the object detection device 100 makes a transition to step S101. On the other hand, in a case of not continuing the processing (step S108: No), the object detection device 100 terminates the processing.

Next, advantages of the object detection device 100 according to one of the present embodiments will be described. The object detection device 100 extracts, from a candidate area of a three-dimensional object, feature points the number of which is greater than or equal to a predetermined number, and identifies feature points of the three-dimensional object, based on observed flow amounts and virtual flow amounts of the respective feature points. In addition, the object detection device 100 corrects the candidate area of the three-dimensional object in conformity with a circumscribed rectangle of the feature points of the three-dimensional object. For this reason, it is possible to accurately detect an area of the three-dimensional object of image data. Therefore, it is possible to correctly estimate a distance to the three-dimensional object and a width thereof.

In a case where a difference between an observed flow amount and a virtual flow amount for a feature point is greater than or equal to the threshold value, the object detection device 100 identifies that the relevant feature point is a feature point of the three-dimensional object. Therefore, from feature points in which feature points of a background and feature points of a road surface pattern are mixed, it is possible to adequately detect feature points of the three-dimensional object. It is possible to inhibit feature points from being excessively detected, and it is possible to inhibit an area other than the three-dimensional object from being detected as a three-dimensional object, for example.

In a case where a difference between a candidate area of the three-dimensional object and a generated area is greater than or equal to the threshold value, the object detection device 100 corrects the candidate area in conformity with the generated area. Therefore, from all candidate areas, it is possible to select the candidate area to be corrected. Therefore, it is possible to reduce a processing load.

The object detection device 100 performs processing for relaxing a condition for feature points, thereby extracting feature points again, until the number of feature points included in a candidate area of an object becomes greater than or equal to a threshold value. Therefore, it is possible to inhibit the degree of accuracy from being reduced due to a small number of feature points.

Note that while, in the explanation of the object detection device 100 according to one of the present embodiments, the object detection device 100 is descried with using the vehicle as an example of the moving object, the moving object may be something other than the vehicle. The moving object may be a vessel, an electric train, a forklift, a robot, a drone, or the like, for example.

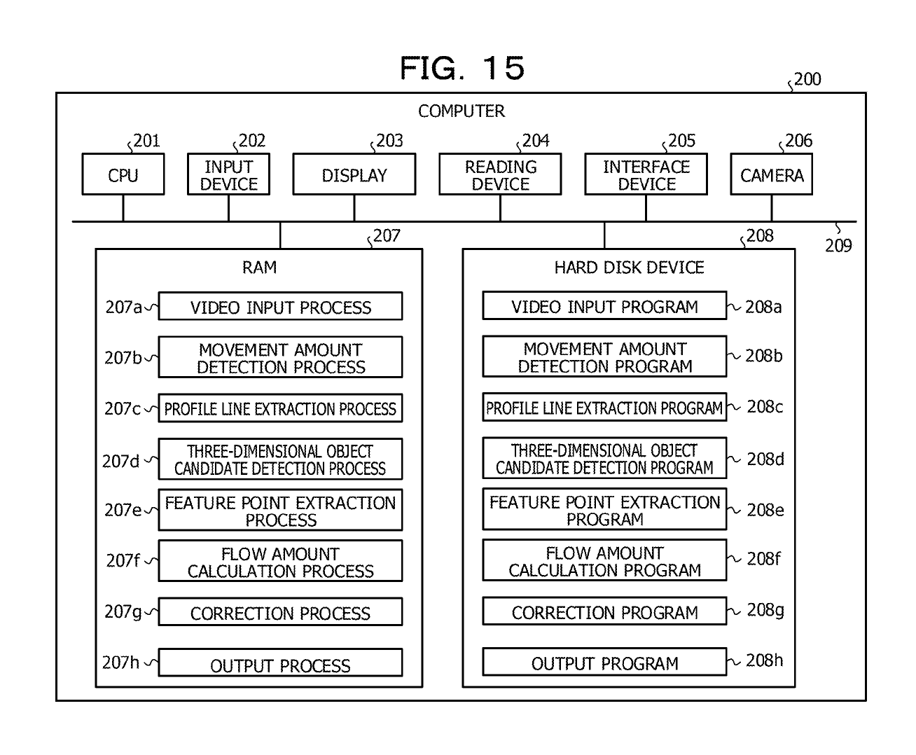

Next, an example of a hardware configuration of a computer for realizing the same function as that of the object detection device 100 illustrated in one of the above-mentioned embodiments will be described. FIG. 15 is a diagram illustrating an example of a hardware configuration of a computer for realizing the same function as that of the object detection device.

As illustrated in FIG. 15, a computer 200 includes a CPU 201 to perform various kinds of arithmetic processing, an input device 202 to receive inputting of data from a user, and a display 203. The computer 200 further includes a reading device 204 to read a program and so forth from a storage medium, an interface device 205 to transmit and receive data to and from another computer via a network, and a camera 206. The computer 200 further includes a RAM 207 to temporarily store therein various kinds of information, and a hard disk device 208. In addition, the devices 201 to 208 are each connected to a bus 209.

The hard disk device 208 includes a video input program 208a, a movement amount detection program 208b, a profile line extraction program 208c, a three-dimensional object candidate detection program 208d, and a feature point extraction program 208e. The hard disk device 208 includes a flow amount calculation program 208f, a correction program 208g, and an output program 208h.

The CPU 201 reads and deploys, in the RAM 207, the video input program 208a, the movement amount detection program 208b, the profile line extraction program 208c, the three-dimensional object candidate detection program 208d, and the feature point extraction program 208e. The CPU 201 reads and deploys, in the RAM 207, the flow amount calculation program 208f, the correction program 208g, and the output program 208h.

The video input program 208a functions as a video input process 207a. The movement amount detection program 208b functions as a movement amount detection process 207b. The profile line extraction program 208c functions as a profile line extraction process 207c. The three-dimensional object candidate detection program 208d functions as a three-dimensional object candidate detection process 207d. The feature point extraction program 208e functions as a feature point extraction process 207e. The flow amount calculation program 208f functions as a flow amount calculation process 207f. The correction program 208g functions as a correction process 207g. The output program 208h functions as an output process 207h.

Processing based on the video input process 207a is equivalent to the processing based on the video input unit 151. Processing based on the movement amount detection process 207b is equivalent to the processing based on the movement amount detection unit 152. Processing based on the profile line extraction process 207c is equivalent to the processing based on the profile line extraction unit 153. Processing based on the three-dimensional object candidate detection process 207d is equivalent to the processing based on the three-dimensional object candidate detection unit 154. Processing based on the feature point extraction process 207e is equivalent to the processing based on the feature point extraction unit 155. Processing based on the flow amount detection process 207f is equivalent to the processing based on the flow amount calculation unit 156. Processing based on the correction process 207g is equivalent to the processing based on the correction unit 157. Processing based on the output process 207h is equivalent to the processing based on the output unit 158.

Note that each of the programs 208a to 208h does not have to be stored in the hard disk device 208 from the beginning. The individual programs are stored in a “portable physical medium” such as, for example, a flexible disk (FD), a CD-ROM, a DVD disk, a magneto-optical disk, or an IC card, which is inserted into the computer 200. In addition, the computer 200 may read and execute the individual programs 208a to 208h.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An object detection device comprising:
a memory; and
a processor coupled to the memory and configured to:
identify a first area including a target object, from a first image captured by a camera at a first time,
extract, from the first area, a predetermined number or more of first feature points,
identify a second area including the target object, from a second image captured by the camera at a second time,
extract, from the second area, second feature points corresponding to the first feature points,
correct the second area of the target object, based on first flow amounts from the first feature points to the second feature points and second flow amounts of the first feature points, the second flow amounts being predicted between the first time and the second time, and
calculate, based on the corrected second area, a distance from the camera to the target object and a width of the target object.

2. The object detection device according to claim 1, wherein
the processor
determines that the extracted feature points are feature points of the target object, in a case where a difference between the first flow amount and the second flow amount is greater than or equal to a threshold value, and
corrects an area of the target object in accordance with a rectangular area including the determined feature points of the target object.

3. The object detection device according to claim 2, wherein
the processor
corrects the area of the target object in accordance with the rectangular area in a case where a difference between the area of the target object and the rectangular area is greater than or equal to a threshold value.

4. The object detection device according to claim 1, wherein
the processor
lowers a threshold value for extracting feature points, thereby extracting feature points again, in a case where the number of feature points included in an area of the target object is less than a predetermined number.

5. An object detection method comprising:
identifying, by a processor, a first area including a target object, from a first image captured by a camera at a first time,
extracting, by a processor, from the first area, a predetermined number or more of first feature points,
identifying, by a processor, a second area including the target object, from a second image captured by the camera at a second time,
extracting, by a processor, from the second area, second feature points corresponding to the first feature points,
correcting, by a processor, the second area of the target object, based on first flow amounts from the first feature points to the second feature points and second flow amounts of the first feature points, the second flow amounts being predicted between the first time and the second time, and
calculating, by a processor, based on the corrected second area, a distance from the camera to the target object and a width of the target object.
